(19) United States
(12) Patent Application Publication
(10) Pub. No.: US 2004/0143658 A1
(43) Pub. Date: Jul. 22, 2004

(54) Method and apparatus for permitting visualizing network data

(76) Inventors: Chris Newton, Douglas (CA); William Bird, Estey's Bridge (CA); Dwight Spencer, Douglas (CA)

Correspondence Address: James C. Scheller, Jr., BLAKELY, SOKOLOFF, TAYLOR & ZAFMAN LLP, Seventh Floor, 12400 Wilshire Boulevard, Los Angeles, CA, 90025-1026, US

(21) Appl. No.: 10/346,920

(22) Filed: Jan. 17, 2003

(51) Int. Cl. G06F 15/173; G09G 5/00

(52) U.S. Cl. 709/224; 345/734

(57) ABSTRACT

Methods and apparatuses for the visualization of network traffic and permitting access thereto are provided. In one aspect of the invention, an illustrative method includes defining a plurality of views of network traffic for the classification of network traffic into the views. At least one of the views is a group view. In one example, the types of views include at least two of the following: network address, application, protocol, flow type, packet type, geographic region, ICMP type, slow scan, operating system, flag, remote host count, local host count, spoofing, fragments, service, sessions, response time, status, and user. In another example, network traffic is classified according to the composite views of various combinations of previously defined views. A master console permits users to access only the portion of the network for which the users is responsible. The permitted view does not show other parts of the network.

### RELATED APPLICATIONS

The present invention relates co-pending U.S. patent application Ser. No. 09/872,995 the entire specification of which is hereby incorporated by reference.

### FIELD OF THE INVENTION

The present invention relates to method and apparatus for permitting visualizing network data.

### BACKGROUND OF THE INVENTION

The rapid development of the Internet, World Wide Web and E-commerce has made it increasingly important to be able to monitor the traffic going into and coming out of a network in order to discover abnormal network traffic that may be an indication of attacks from hackers or misuse of network resources by users inside the network. A network of computers may be attacked by a hacker using Smurf, Denial of Services (DoS), or be abused by a rogue employee within the network, who may attack some other networks or download pornography. Various network security software, such as firewalls, Intrusion Detection Systems (IDS), network monitors, and vulnerability assessment tools, have been developed to protect a network from abuse and hacking.

Firewalls are now a mature technology. Firewalls selectively block certain types of network traffic from going into or coming out of a protected network. However, they must allow some types of network traffic to go through in order to facilitate desired network communications, such as accessing websites and transporting e-mails. Although firewalls are a mature technology, it is well known that they are far from failsafe. File Transfer Protocol (FTP) service uses port number 21. To facilitate FTP service a firewall allows such traffic to go through. A hacker thus can focus on attacks using this port number, and firewalls cannot stop the hackers using the FTP service for illegal or improper purposes. Network traffic can talk on more than 65,000 ports. A large percentage of firewalls are misconfigured so that they inadvertently let in traffic that is supposed to be blocked.

IDS systems are used to spot, alert, and stop intrusions. Typically running on dedicated computers hooked to the network, IDS systems actively monitor network traffic for suspicious activities. Statistics or rule-based artificial intelligence is used to detect abnormal activities. Thus, IDS systems depend on the recognition of known attack patterns. For example, contents in the network traffic may be monitored to match the patterns in an IDS system's databases. The real-time analysis of the network traffic provides the capability to send instant notifications via e-mails, pager alerts, or other means. Based on a predefined security policy, some IDS systems can take defensive actions against intrusions, such as initiating the termination of network connections or changing the configuration of network devices (e.g., firewalls and routers). Since hacking activities and misuse of new patterns are under constant development, IDS systems are also under constant development. IDS systems have a number of weaknesses. IDS systems depend on the recognition of known attack patterns, sequences, or signatures. Currently known signatures of attacks are collected to write rules to detect and disable network activities with these signatures. However, IDS systems cannot detect or stop the attacks of unknown signatures. IDS systems have to be upgraded when the rules are updated to handle attacks of signatures that are only recently recognized.

Sniffers are network monitors. A sniffer captures and decodes the network traffic traversing a transmission medium. Typically, when network administrators are alerted of system problems by users, or intrusions by IDS systems, or other events (e.g., a server goes down), they use a sniffer to monitor the network traffic after reviewing audit logs. The sniffer “dives” into the network traffic data to see all the detailed information. Extremely detailed information about what is transmitted in the network is shown. However, the information provided by a sniffer is so voluminous that it is technically challenging, as well as time consuming, to analyze the data provided by a sniffer.

Network administrators are frustrated by the absence of software programs, which let them see at a glance how their network is used, or abused, and who is responsible for a specific activity. Therefore, it is desirable to have a powerful tool to help administrators to organize the information about network traffic so that they can easily explore the information in an intuitive and efficient way in order to detect intrusion and misuse.

### SUMMARY OF THE INVENTION

An object of the present invention is to provide an improved method and apparatus for permitting visualizing network data.

Methods and apparatuses for the access to visualization of network traffic are described here.

The network traffic being monitored is classified into a number of views of network traffic. A view of network traffic is a subset of network traffic that satisfies a set of conditions. A view can be directly defined by a set of conditions it must satisfy. It can be also defined as a group view, which has a number of previously defined views as its members. A composite view of a set of views is the intersection of the network traffic of the given set of views. A type of condition applied on the network traffic to form a view is the type of the view.

The types of the views includes at least one of the following: (a) remote hosts count; (b) local host count; (c) flow type; (d) packet type; (e) IP range; (f) status; and (g) user.

An illustrative method for displaying a graphical representation of data relating to network traffic includes: receiving a request for a view of network traffic specified by first parameters in a form of a Graph Request Language (GRL); and displaying the requested view on a display device. The Graph Request Language has constructs that are pre-defined based on configuration files that specify second parameters including network address spaces.

In an aspect of the invention, there is provided a method of permitting access to views of network traffic data including the steps of: defining a plurality of views of network traffic; for a given user, selecting a view; and associating the given user with the selected view.

In another aspect of the invention, there is provided a method of permitting access to views of network traffic data including the steps of: defining a plurality of views of network traffic; for a given user, selecting a set of views; forming a group view for the set of views; and associating the given user with the group view.

In another aspect of the invention, there is provided a method of monitoring network traffic including the steps of: defining a plurality of views, generating a menu for accessing composite views of various combinations of the previously defined views; generating a menu item for a group view for accessing members of the group view associated with the menu item; permitting access to the group view by associating a given user therewith.

The present invention includes apparatuses that perform these methods; including data processing systems that perform these methods and computer-readable media, which when executed on data processing systems, cause the systems to perform these methods.

### BRIEF DESCRIPTION OF THE DRAWINGS

The present invention will be further understood from the following detailed description with reference to the drawings in which:

FIG. 1 illustrates in a block diagram an apparatus for permitting access to a visual representation of a network in accordance with an embodiment of the present invention;

FIG. 2 graphically illustrates a hierarchy representing physical and logical views of a network;

FIG. 3 illustrates in a flow chart a method of permitting access in accordance with an embodiment of the present invention;

FIG. 4 illustrates in a flow chart a method of permitting access to views of network data in accordance with a second embodiment of the present invention; and

FIG. 5 illustrates in a flow chart a method of selecting a view by the user of the group view of FIG. 4.

### DETAILED DESCRIPTION OF THE PREFERRED EMBODIMENT

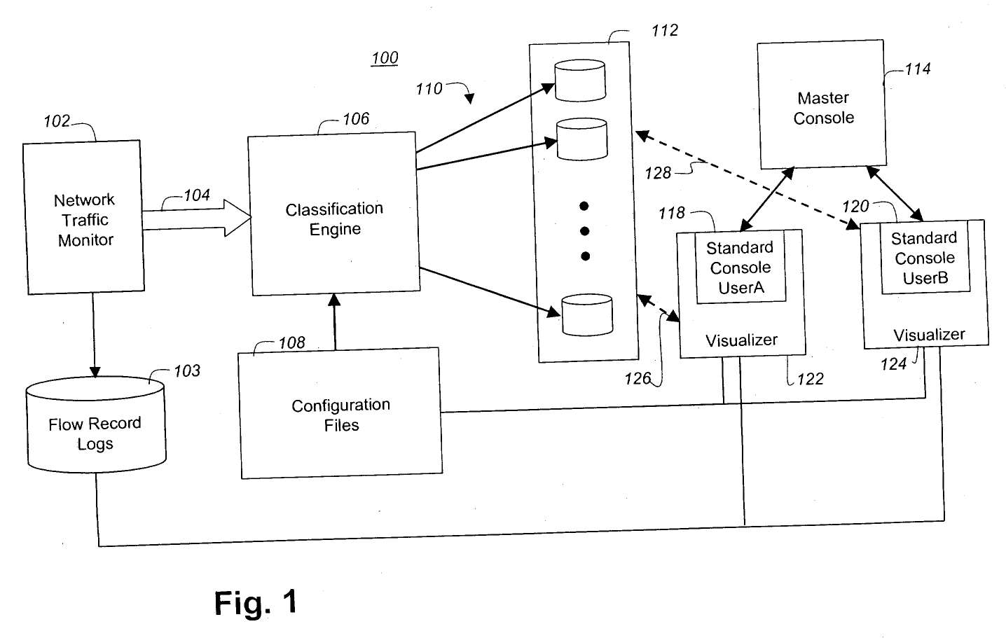

Referring to FIG. 1 there is illustrated in a block diagram an apparatus for permitting access to a visual representation of a network in accordance with an embodiment of the present invention. The traffic visualization apparatus 100 includes a network traffic monitor 102 that is coupled to a portion of the network (not shown) a flow record logs storage 103 and also provides flow records 104 to a classification engine 106. The classification engine 106 uses configuration files 108 to classify the flow records into a number of different views, each having activity records 110, stored in corresponding databases 112. A master console 114 is coupled to a plurality of standard consoles, for example userA 118 and userB 120 having visualizers 122 and 124, respectively, each visualizer communicates with the databases 112 to render a graphical representation of the network activity for each view. The master console provides GRL links into standard consoles. The standard consoles, provide access to the databases. It is the standard consoles themselves that limit the user's access to database under it's control. Thus, userA and userB have limited access to the databases 110 as represented by broken arrows 126 and 128, respectively. UserA and UserB, can exist on both standard console A and standard console B, and yet, have totally separate permissions, or overlapping permissions at each standard console. Master console provides a way to tie all of the standard consoles together.

For example, if one were using a master console that has numerous standard consoles under its control, laid out in a hierarchical menu in a left pane, then when one clicks on a particular standard console, it is that selected standard console that limits one's views to the parts of the network for which it has been configured to be allowed to see.

While moving around, one can copy ‘branches’ from any location one is permitted to see, and create new branches for one's use, under the master console's left pane hierarchical menu, to use as shortcuts to the parts of the network one uses frequently.

Additionally, the master console, collects alert events being generated on the various standard consoles, filters the events based on the privileges set on that console, and displays all of the alert events from the multiple standard consoles, in one screen. This is similar to what a standard console does, when one goes to the alert pane, but, the master console can do it for a given user, across a number of standard consoles.

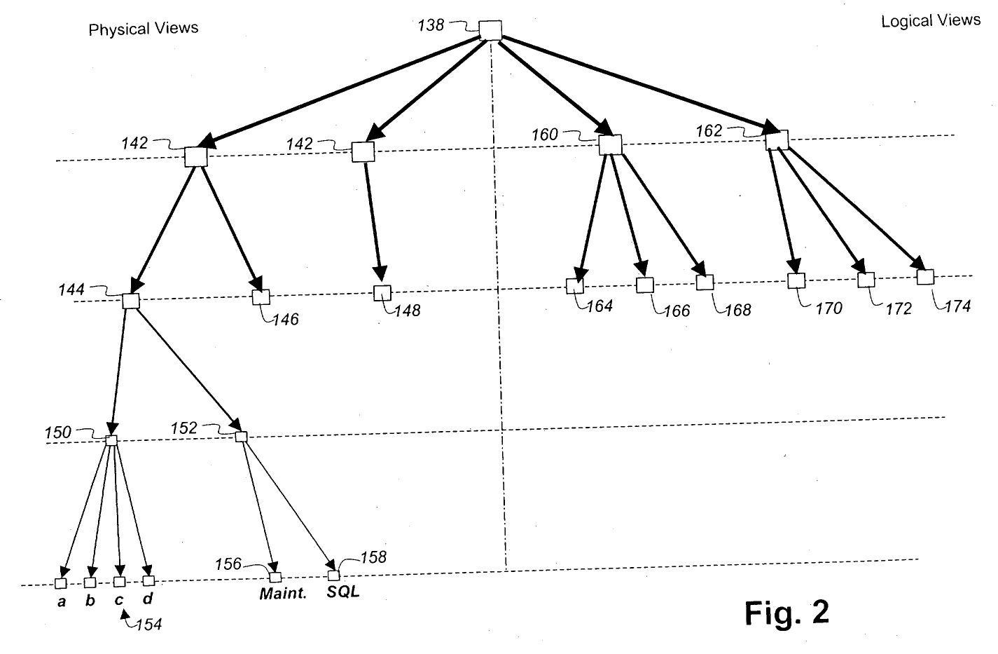

The configuration files define the views of the network that can be visualized. Referring to FIG. 2, there is graphically illustrated a hierarchy representing physical and logical views of a network. The network 138 includes two subnets 140 and 142. The subnet 142 includes a server farm 144 and a node 146, while subnet 142 include a node 148 (for simplicity of the illustration only one branch is expanded at lower levels in the hierarchy).

The server farm 144 includes web servers 150 and databases 152. The web servers 150 include web servers (a, b c and d) 154. The databases 152 include a maintenance database 156 and an SQL database 158.

The configuration files also define logical views of the network, for example professionals 160 and support staff 162. The professionals may be further subdivided into executives 164, managers 166 and non-managers 168. The support staff may also be subdivided into, for example, executive assistants 170, administrative assistants 172 and clerical support 174.

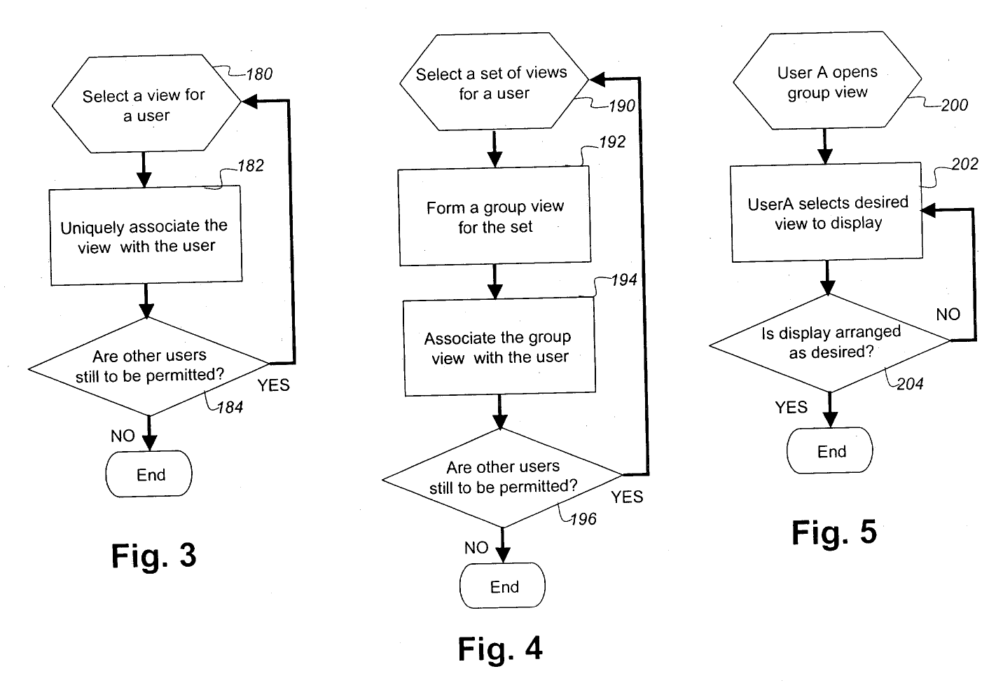

The Master Console 114 can permit users unique access to the network views at a single point in the hierarchy, thereby segregating multiple users of the system. Alternatively, the master console can group an number of points in the hierarchy into a view tailored to the needs of a particular user. These options are described in further detail with regard to FIGS. 3 and 4, respectively.

Referring to FIG. 3, there is illustrated in a flow chart a method of permitting access in accordance with an embodiment of the present invention. At the master console 114 a view is selected for a given user as represented by a preparation block 180. For example, the view of the server farm 144 may be selected for userA of FIG. 1. The view 144 is uniquely associated with userA as represented by a process block 182. Are any other users are to be permitted, as represented by a decision block 184, if yes, a view is selected for the next user as represented by block 180 the process step 182.

The permitting provided by the method of FIG. 3, provides for segregation of multiple users of the visualization system. By uniquely associating each user with a particular point in the configuration hierarchy, only those views intended to be seen by the user are made available. The network hierarchy above the permitted view is collapsed, so that the user is unaware of the structure of the rest of the network. Thus, for the example of the userA being permitted to view traffic for server farm 144, the userA would be able to see only the portion of the graph below 144 and connected thereto.

In many network administration situations, permissions based upon the hierarchy of the network views is sufficient to meet the needs of network administrators. However, once further experience is gained with administering the network permissions linked directly to views defined in the configuration files may prove too inflexible for certain situations.

Referring to FIG. 4 there is illustrated in a flow chart a method of permitting access to views of network data in accordance with a second embodiment of the present invention. The method of FIG. 4 begins with selecting a set of views for a user as represented by a block 190. A group view is formed from the set as represented by a process block 192 and the group view is associated with the user as represented by a process block 194. If other users are to be permitted access as queried by decision block 196, the method returns to step 190.

The method of FIG. 4 allows a network administrator not only to delegate views to subordinates, but also to customize the views permitted to each user. For example, if userA were permitted to view the server farm traffic 144, but also needed to monitor how the traffic for the managerial staff in general compared to that of the server farm, a group view could be formed that included the server farm traffic 144 and the management traffic 166.

Referring to FIG. 5, there is illustrated in a flow chart a method of selecting a view by the user of the group view of FIG. 4. A user opens a group view as represented by a block 200. A user selects a desired view to display as represented by a process block 202. If the display is as desired as determined by a decision block 204, the method ends, otherwise the user makes further adjustments at process block 202.

What is claimed is:

1. A method permitting access for monitoring network traffic, said method comprising:
defining a plurality of views of network traffic, each of the views containing a subset of network traffic that satisfies a set of conditions, and at least one of the views is a group view comprising two or more previously defined views as members;
classifying network traffic passing through a network component according to the views;
selecting a group view for permitting access to a given user; and
associating the given user with the group view.

2. A method as in claim 1 wherein types of conditions imposed on the views are based on data categories comprising at least one of the following: network address, application, protocol, flow type, packet type, geographic region, ICMP type, slow scan, operating system, flag, remote host count, local host count, spoofing, fragments, service, sessions, response time, status, and user.

3. A method permitting access to a system for monitoring network traffic, said method comprising:
defining parameters relating to a network configuration of a network;
generating graphical user interface menu items based on said parameters, a first set of parameters producing a first set of menu items and a second set of parameters producing a second set of menu items; and
for a given user, permitting access to at least one set of menu items by associating the given user therewith.

4. A method as claimed in claim 3 wherein said parameters define a plurality of views of network traffic.

5. A method as claimed in claim 4 wherein each of the views contains a subset of network traffic that satisfies a set of conditions.

6. A method as claimed in claim 5 wherein a part of the menu items are related to the views.

7. A method as in claim 6 wherein a subset of the views is based on different data categories.

8. A method as claimed in claim 7 wherein a part of the menu items are related to a composite view of the subset of the views, wherein the composite view contains an intersection of network traffic of the subset of the views.

9. A method for monitoring network traffic, said method comprising:
defining a plurality of views of network traffic, each of the views containing a subset of network traffic that satisfies a set of conditions and at least one of the views is a group view comprising two or more previously defined views as members;
associating a given user with the group view thereby giving access thereto; and
the given user displaying the group view of network traffic.

10. A method as in claim 9 further comprising:
determining a selection of a selected group view;
displaying network traffic of members of the selected group view;
displaying, in response to a selection of a selected member of the selected group view, network traffic of the selected member.

11. A method permitting access for monitoring network traffic, said method comprising:
defining a plurality of views of network traffic, each of the views containing a subset of network traffic that satisfies a set of conditions, and at least one of the views is a group view comprising two or more previously defined views as members;
classifying network traffic passing through a network component according to the views;
forming a group view from a set of selected views;
selecting the group view for permitting access to a given user; and
associating the given user with the group view.

12. A method as in claim 11 wherein types of conditions imposed on the views are based on data categories comprising at least one of the following: network address, application, protocol, flow type, packet type, geographic region, ICMP type, slow scan, operating system, flag, remote host count, local host count, spoofing, fragments, service, sessions, response time, status, and user.

13. A method permitting access to a system for monitoring network traffic, said method comprising:
defining parameters relating to a network configuration of a network;
generating graphical user interface menu items based on said parameters, a first set of parameters producing a first set of menu items and a second set of parameters producing a second set of menu items; and
restricting graphical user interface menu items presented to a given user by associating a subset of menu items with the given user.

14. A method as claimed in claim 13 wherein said parameters define a plurality of views of network traffic.

15. A method as claimed in claim 14 wherein each of the views contains a subset of network traffic that satisfies a set of conditions.

16. A method as claimed in claim 15 wherein a part of the menu items are related to the views.

17. A method as in claim 16 wherein a subset of the views is based on different data categories.

18. A method as claimed in claim 17 wherein a part of the menu items are related to a composite view of the subset of the views, wherein the composite view contains an intersection of network traffic of the subset of the views.

19. A machine readable media containing executable computer program instructions which when executed by a digital processing system causes said system to perform a method comprising:
permitting access for monitoring network traffic, said method comprising:
defining a plurality of views of network traffic, each of the views containing a subset of network traffic that satisfies a set of conditions, and at least one of the views is a group view comprising two or more previously defined views as members;
classifying network traffic passing through a network component according to the views;
selecting a group view for permitting access to a given user; and
associating the given user with the group view.

20. A media as in claim 19 wherein types of conditions imposed on the views are based on data categories comprising at least two of the following: network address, application, protocol, flow type, packet type, geographic region, ICMP type, slow scan, operating system, flag, remote host count, local host count, spoofing, fragments, service, sessions, response time, status, and user.

21. A machine-readable media containing executable computer program instructions, which when executed by a digital processing system causes said system to perform a method comprising:
defining parameters relating to a network configuration of a network;
generating graphical user interface menu items based on said parameters, a first set of parameters producing a first set of menu items and a second set of parameters producing a second set of menu items; and
for a given user, permitting access to at least one set of menu items by associating the given user therewith.

22. Apparatus for permitting access for monitoring network traffic comprising:
configuration files for defining a plurality of views of network traffic, each of the views for containing a subset of network traffic that satisfies a set of conditions, and at least one of the views is a group view comprising two or more previously defined views as members;
a classification engine for classifying network traffic passing through a network component according to the views; and
a master console for selecting a group view for permitting access to a given user and associating the given user with the group view.

23. Apparatus as in claim 22 wherein types of conditions imposed on the views are based on data categories comprising at least one of the following: network address, application, protocol, flow type, packet type, geographic region, ICMP type, slow scan, operating system, flag, remote host count, local host count, spoofing, fragments, service, sessions, response time, status, and user.

24. Apparatus for permitting access to a system for monitoring network traffic comprising:
configuration files for defining parameters relating to a network configuration of a network;
a graphical user interface for generating menu items based on said parameters, a first set of parameters producing a first set of menu items and a second set of parameters producing a second set of menu items; and
a master console for permitting a given user access to at least one set of menu items by associating the given user therewith.

25. Apparatus for permitting access for monitoring network traffic comprising:
configuration files for defining a plurality of views of network traffic, each of the views for containing a subset of network traffic that satisfies a set of conditions, and at least one of the views is a group view comprising two or more previously defined views as members;
a classification engine for classifying network traffic passing through a network component according to the views; and
a master console for forming a group view from a set of selected views, selecting the group view for permitting access to a given user, and associating the given user with the group view.

26. Apparatus as in claim 22 wherein types of conditions imposed on the views are based on data categories comprising at least one of the following: network address, application, protocol, flow type, packet type, geographic region, ICMP type, slow scan, operating system, flag, remote host count, local host count, spoofing, fragments, service, sessions, response time, status, and user.

27. Apparatus for permitting access to a system for monitoring network traffic comprising:
configuration files for defining parameters relating to a network configuration of a network;
a graphical user interface for generating menu items based on said parameters, a first set of parameters producing a first set of menu items and a second set of parameters producing a second set of menu items; and
a master console for restricting graphical user interface menu items presented to a given user by associating a subset of menu items with the given user.
